(19) United States
(12) Patent Application Publication
(10) Pub. No.: US 2004/0157483 A1
(43) Pub. Date: Aug. 12, 2004

(54) Vibration resistant wireless interconnection system

(75) Inventors: Vladimir Karasik, Oakland, MI (US); Joseph E. Khoury, Stromberg (DE); Michael Shahan, Allen Park, MI (US)

Correspondence Address: BLANK ROME LLP, 600 NEW HAMPSHIRE AVENUE, N.W., WASHINGTON, DC, 20037, US

(73) Assignee: Methode Electronics, Inc.

(21) Appl. No.: 10/364,031

(22) Filed: Feb. 11, 2003

(51) Int. Cl. H01R 4/38

(52) U.S. Cl. 439/382

(57) ABSTRACT

A connection module having multiple spring coils that connect the electrical contacts of a steeling stalk to the electrical contacts of a circuit board in a steering column. The spring coils are made from a conductive wire that is formed into a helix-shaped coil having several rings therein, the rings defining slots therebetween. The spring coils are placed end to end in the connection module so that access is provided to the slots in the sides of the spring coils. The contacts of the steering stalk and the circuit board are then inserted into the slots of the spring coil to electrically connect the two.

### FIELD OF INVENTION

The present invention is directed towards an electrical connection system that uses a conductive spring coil to connect the electrical contacts of a function module, such as a turn signal stalk, to a circuit board or control module inside a steering column of an automobile.

### BACKGROUND OF THE INVENTION

A steering wheel column typically includes multiple function modules, such as a wiper module and turn signal module, for controlling various functions of a car. These function modules are elongated stalks that are connected to a main circuit board inside the steering column and extend out therefrom. The function module typically includes knobs and buttons to control various car functions, such as the window wipers, turn signals, headlights, etc.

The function module stalks are typically connected to the circuit board using corresponding male pins and female sockets. However, these connections are vulnerable to becoming dislodged due to the sustained, and sometimes sever, vibrations generated by the car engine and road conditions. An additional drawback to the male pin and female socket connection is that they must be precisely aligned so that each male pin aligns with its corresponding female socket. The precision necessary to properly align the pin and socket increases the manufacturing costs of the connection system.

An alternative method to using male pins and female sockets is shown in FIG. 1, which depicts a function module 100 having a leaf spring 102, and a control module 110 with a printed circuit board 112. The circuit board 112 includes a contact pad 114 that engages the flat leaf spring 102 to electrically connect the circuit board 112 to the function module 100. However, this method of attachment is unreliable because the contact between the leaf spring 102 and the contact pad 114 depends on the contact force generated by the leaf spring 102, which is greatly affected by vibrational disturbances. Additionally, the contact force may be decreased due to a reduction in the elasticity of the spring leaf over the course of its use. Also, air gap instability caused by deviations in the parts' dimensions and deviations produced during assembly of the parts may further reduce the contact force anywhere from +/−30-40%.

Therefore, it would be desirable to provide simple and reliable electrical connection modules that mitigate vibrational effects to reduce the possibility of separation between electrical components. Additionally, it would be desirable to provide an electrical connection module that can accommodate contacts which are unevenly or improperly spaced to reduce manufacturing costs.

### SUMMARY OF THE INVENTION

The present invention is directed to connection modules that include multiple spring coils that connect the electrical contacts of a function module, such as a steering stalk, to the electrical contacts of a circuit board in a steering column. The spring coils are made from a conductive wire that is, preferably, formed into a helix-shaped coil having several turns therein. The spring coils are placed end to end in the connection module so that the turns or rings along the length of the spring coil define slots therebetween. The contacts of the function module and the circuit board are then inserted into the slots of the spring coil.

### BRIEF DESCRIPTION OF THE DRAWINGS

FIG. 1 shows an exploded view of a prior art leaf spring connection system;

FIG. 2 shows an exploded view of a steering column in accordance with the invention;

FIG. 3 shows a perspective view of a connection module in accordance with the invention;

FIG. 4 shows a detailed front view of the spring coils of the connection module in accordance with the invention; and

FIG. 5 shows an end view of a spring coil with electrical contacts inserted therein in accordance with the invention.

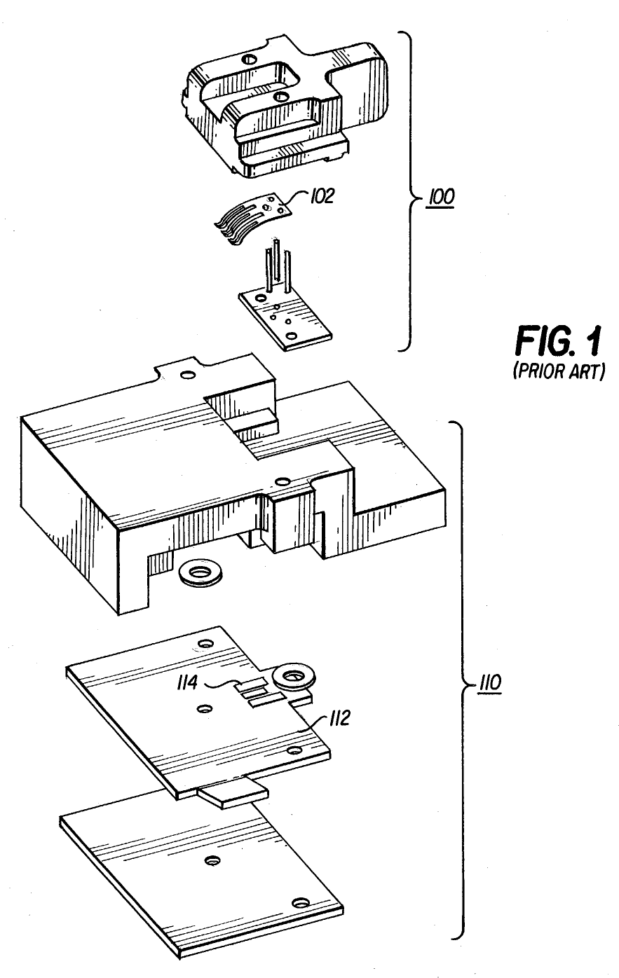

### DETAILED DESCRIPTION OF THE PREFERRED EMBODIMENTS OF THE INVENTION

Referring now to the several drawing figures in which identical elements are numbered identically throughout, a description of the preferred embodiments of the present invention will be provided.

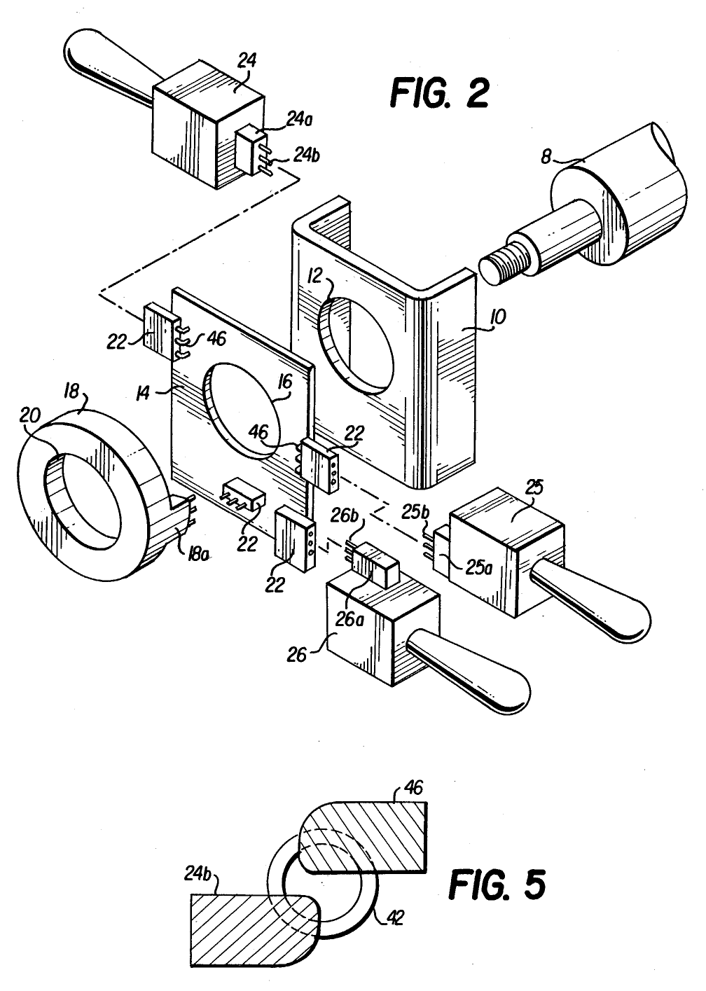

FIG. 2 shows an exploded view of a steering column assembly having a steering column 8 placed through an opening 12 of a mounting bracket 10, opening 16 of a printed circuit board 14, and opening 20 of a clockspring 18. The function and purpose of the mounting bracket 10 and clockspring 18 are well known in the art and will not be further discussed.

The present invention is directed towards connection modules 22 located on the circuit board 14. The circuit board 14 provides a central location for the attachment of the electrical components in the steering column, such as the steering stalks 24-26. Although the circuit board 14 is shown as a separate component, it should be understood that the circuit board 14 can be a part of a larger system or control module.

The circuit board 14 and the steering stalks 24-26 are connected to one another by way of the connection module 22. The circuit board 14 includes contacts 46 that are attached to the connection modules 22, and the function modules 24-26 have connectors 24a-26a, which include contacts 24b-26b that connect the connection modules 22.

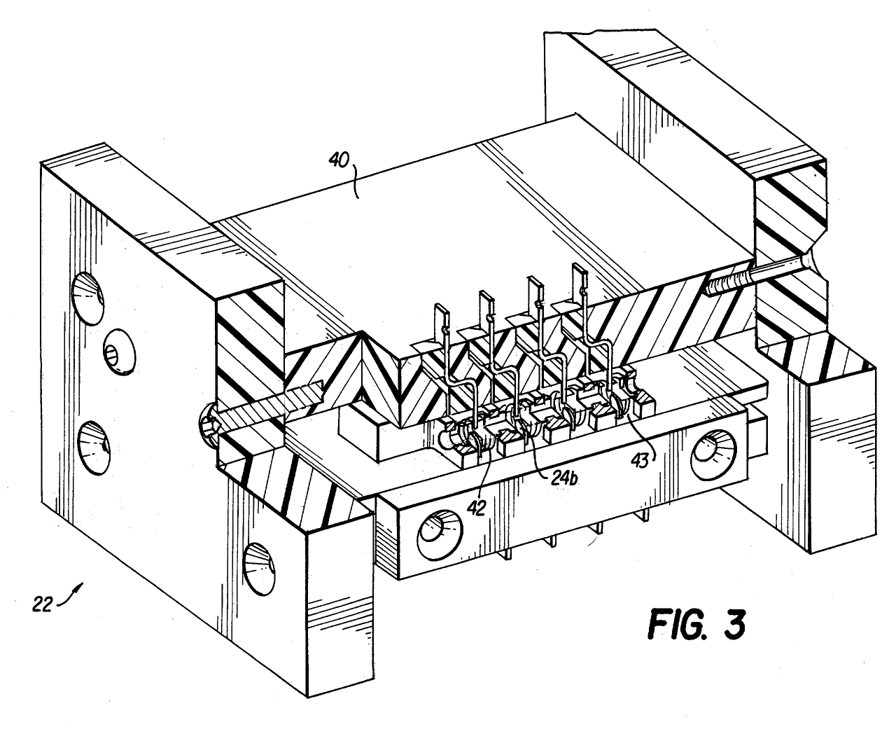

FIG. 3 shows an enlarged view of an connection module 22, which shows a series of spring coils 42 placed in a chamber 43 in the interior of a housing 40. The spring coils 42 are secured at their ends so that the spring coils 42 are not fully compressed and the rings 44 along the side of the spring coils are exposed. The spring coils 42 are slightly, but not fully compressed when placed into the housing 40 so that the internal stress of the spring coils 42 apply an outward force against the housing, ensuring that the spring coils 42 remained secured in place.

Each spring coil 42 is preferably formed from a single conductive wire that is bent into a helix-shaped spring. The spring coils 42 include several rings 44 along its length which define slots 45 therebetween for the insertion of the circuit board contacts 46 and function module contacts 24b-26b.

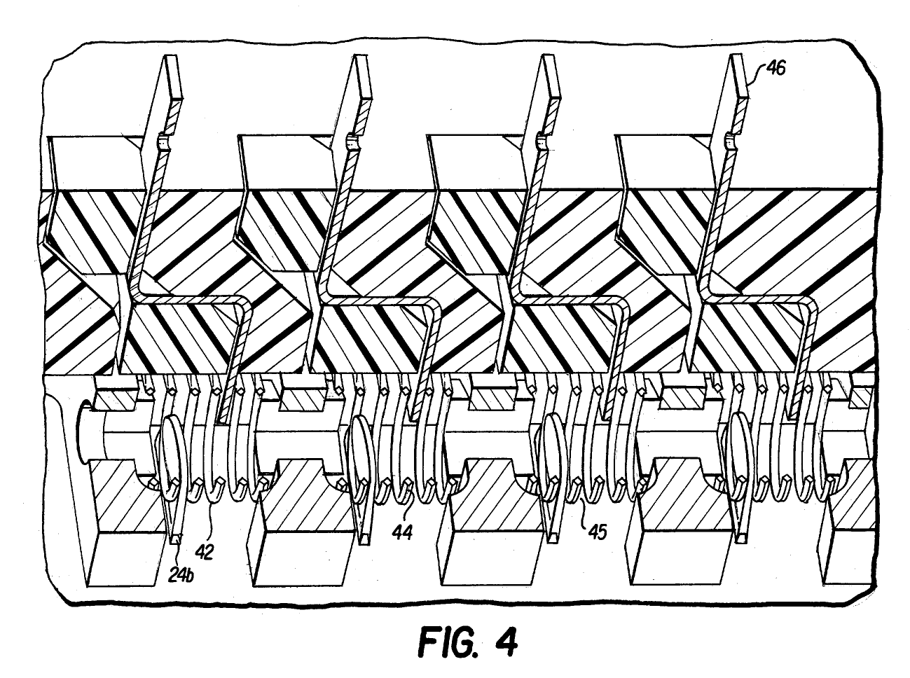

FIG. 4 shows the circuit board contacts 46 inserted into the slots 45 of the spring coils 42 of the connection module 22. The function module contacts 24b-26b are inserted from an opposite side of the spring coil 42, with its contacts being inserted into adjacent slots 45, as shown in FIG. 5.

The spring coils 42 provide several advantages. As stated earlier, the spring coils 42 are slightly compressed in the housing so that their outward biasing force help retain them in the housing. The compressed nature of the spring coils 42 also provides a retention force so that the rings 44 grip the contacts inserted into the slots 45, thus reducing the possibility that the contacts will become detached. Additionally, because the spring coils 42 are flexible, the slots 45 are able to shift their position to compensate for slight misalignments of the contacts. Larger misalignments are accommodated by the spring coils' 42 multiple slots 45, whereby the contacts are inserted into the slot 45 that most closely matches its misaligned position.

It should be understood that although the description of the invention has been given in reference to a connection module 22 to connect function modules 24-26 to a circuit board 14 in the steering column of an automobile, the invention may be used to connect any electrical component in a steering column, and even more broadly, may be used to connect any electrical components in any environment.

Furthermore, although certain presently preferred embodiments of the present invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. An electrical connector module comprising:
a housing; and
one or more spring coils being secured within said housing and being made of a resilient electrically conductive material, each spring coil having a plurality of rings defining slots therebetween to hold contacts of an electrical component.

2. The electrical connector module of claim 1, wherein:
the one or more spring coils are secured in the housing in a compressed state.

3. The electrical connector module of claim 1, wherein:
the one or more spring coils are secured in the housing at their ends so that the slots in the sides of the spring coils can be accessed.

4. The electrical connector module of claim 1, wherein:
the spring coil is made from a single electrically conductive wire in the shape of a helix.

5. An electrical connection system for connecting electrical components, comprising:
a connector module having a housing and one or more spring coils secured within said housing, the spring coils being made of a resilient electrically conductive material and having a plurality of rings defining slots therebetween;
one or more electrical components having contacts, wherein the contacts are inserted into the slots of the spring coils.

6. The electrical connector module of claim 5, wherein:
the one or more spring coils are secured in the housing in a compressed state.

7. The electrical connector module of claim 5, wherein:
the one or more spring coils are secured in the housing at their ends so that the slots in the sides of the spring coils can be accessed.

8. The electrical connector module of claim 5, wherein:
the spring coil is made from a single electrically conductive wire in the shape of a helix.

9. An electrical connection system for connecting electrical components in an automotive steering column, comprising:
a connector module having a housing and one or more spring coils secured within said housing, the spring coils being made of a resilient electrically conductive material and having a plurality of rings defining slots therebetween;
one or more electrical components having contacts, wherein the contacts are inserted into the slots of the spring coils.

10. The electrical connector system of claim 9, wherein:
the one or more electrical components are steering stalks for controlling automotive functions.

11. The electrical connector system of claim 10, wherein:
the connector module electrically connects the steering stalks to a circuit board.

12. The electrical connector system of claim 9, wherein:
the one or more spring coils are secured in the housing in a compressed state.

13. The electrical connector system of claim 9, wherein:
the one or more spring coils are secured in the housing at their ends so that the slots in the sides of the spring coils can be accessed.

14. The electrical connector system of claim 9, wherein:
the spring coil is made from a single electrically conductive wire in the shape of a helix.
